(19) United States
(12) Patent Application Publication
(10) Pub. No.: US 2011/0255189 A1
(43) Pub. Date: Oct. 20, 2011

(54) METHOD OF DETECTING TOUCHDOWN OF MAGNETIC HEAD USING TIMESTAMPS, AND MAGNETIC DISK DRIVE TO WHICH THE METHOD IS APPLIED

(75) Inventors: Motomichi SHIBANO, Ome-shi (JP); Kazuto Kashiwagi, Ome-shi (JP); Kazuhito Shimomura, Fussa-shi (JP)

(73) Assignee: Kabushiki Kaisha Toshiba, Tokyo (JP)

(21) Appl. No.: 12/984,517

(22) Filed: Jan. 4, 2011

(30) Foreign Application Priority Data
Apr. 15, 2010 (JP) 2010-094185

(51) Int. Cl. G11B 27/36; G11B 21/02

(52) U.S. Cl. 360/75; 369/53.41; G9B/27.052; G9B/21.003

(57) ABSTRACT

According to one embodiment, a method of detecting contact of a magnetic head with a magnetic disk by changing the dynamic flying height of the magnetic head in a magnetic disk drive is disclosed. The method can detect a change in the rotational speed of the magnetic disk. The method can detect the contact of the magnetic head with the magnetic disk based on the detected change in the rotational speed.

### CROSS-REFERENCE TO RELATED APPLICATIONS

This application is based upon and claims the benefit of priority from Japanese Patent Application No. 2010-094185, filed Apr. 15, 2010; the entire contents of which are incorporated herein by reference.

### FIELD

Embodiments described herein relate generally to a method of detecting touchdown of a magnetic head using timestamps, and a magnetic disk drive to which the method is applied.

### BACKGROUND

In recent magnetic disk drives, in accordance with increases in magnetic recording density, there is a tendency for the circumferential length of a mark recorded on a magnetic recording medium (namely, a magnetic disk) to become shorter, and for the radial width of a track on the magnetic disk to become narrower. Accordingly, to enhance the quality of read/write signals, it is necessary to narrow the distance (more specifically, magnetic spacing) between the magnetic disk and a magnetic head.

In light of the above, in the recent magnetic disk drives, the magnetic head has a heating element for adjusting the distance between the magnetic head and the magnetic disk (more specifically, the distance between the read/write element of the magnetic head and the magnetic disk) by thermal expansion of the magnetic head. In other words, in the recent magnetic disk drives, the dynamic flying height of the magnetic head flying over the magnetic disk can be controlled.

The dynamic flying height of the magnetic head can be easily controlled by power called dynamic flying height power (hereinafter referred to as “the DFH power”) supplied to the heating element. However, unless the state (touchdown state) in which the magnetic head touches the magnetic disk is detected, it is difficult to execute accurate flying height control.

In the prior art, the touchdown (TD) of the magnetic head is detected based on, for example, a track position error signal (PES), as follows: Firstly, when tracking control is executed with the magnetic head kept flying normally, the PES has a preset value. A change in the PES indicates the accuracy of positioning. When the flying height of the magnetic head is reduced to cause the magnetic head to touch the magnetic disk, vibration due to the touch occurs in the magnetic head radially with respect to the magnetic disk. At this time, an abnormal change in the PES can be observed. Utilizing this phenomenon, the touchdown of the magnetic head can be detected.

Further, when the magnetic head touches the magnetic disk, a vibration component is observed along the normal line of the magnetic disk. This state appears as a variation in the amplitude of a read signal. In the case of, for example, a servo signal or a data signal, a change in the read signal can be detected as the value of a variable gain amplifier (VGA) incorporated in a read channel (RDC).

The phenomenon in which the magnetic head vibrates due to touchdown generally depends upon the radial position on the magnetic disk. At the inner and outer circumferential portions of the magnetic disk, vibration of a greater magnitude appears in the magnetic head due to touchdown, whereas at the (radially) middle portion of the disk, vibration of a smaller magnitude occurs in the magnetic head. This is because at the middle portion, the contact friction force of the magnetic head is influenced by a skew angle to thereby produce a vibration force exerted therein radially with respect to the disk. As a result, it is easy to detect touchdown at the inner and outer circumferential portions of the disk, while it is difficult to detect the same at the middle portion since the signal level is low. Furthermore, measured values for detecting touchdown vary because of the influence of warpage of the magnetic disk or because of the lubricant agent on the disk.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a view useful in explaining an exemplary principle for detecting the touchdown of a magnetic head, according to an embodiment;

FIG. 2A is a view illustrating an arrangement example of servo areas on a magnetic disk in the embodiment;

FIGS. 2B and 2C are views useful in explaining relationship examples in the embodiment between a change in the rotational speed of the magnetic disk and a timestamp change;

FIG. 3A is an example of a curve representing a timestamp change in a non-touchdown state and a curve representing a timestamp change in a touchdown state, which occur in the embodiment;

FIG. 3B is an example of a curve representing a timestamp difference in the embodiment;

FIG. 3C is an example of a curve representing difference accumulation values corresponding to respective dynamic flying height power levels in the embodiment;

FIG. 4A is an example of a curve representing a timestamp change that occurs in the embodiment when the dynamic flying height of the magnetic head is periodically controlled;

FIG. 4B is an example of a curve representing a timestamp change in the touchdown state and a curve representing a timestamp change in the non-touchdown state, which occur in the embodiment when the dynamic flying height of the magnetic head is periodically controlled;

FIG. 5A is an example of a curve representing a timestamp change that occurs in the embodiment when the state in which the dynamic flying height of the magnetic head is not controlled, and the state in which the dynamic flying height of the magnetic head is controlled are set successively;

FIG. 5B is an example of a curve representing results obtained by subjecting, to fast Fourier transform, the timestamps assumed in the state in which the dynamic flying height of the magnetic head is not controlled;

FIG. 5C is an example of a curve representing results obtained by subjecting, to fast Fourier transform, the timestamps assumed in the state in which the dynamic flying height of the magnetic head is controlled;

FIG. 5D is an example of a curve representing changes in differences between the operation results of FIGS. 5B and 5C;

FIG. 6 is a block diagram illustrating an exemplary configuration of a magnetic disk drive according to the embodiment;

FIG. 7 is a flowchart useful in explaining an exemplary procedure for measuring touchdown employed in the embodiment;

FIG. 8 is a flowchart useful in explaining an exemplary procedure for measuring timestamp values employed in the embodiment;

FIGS. 9A and 9B are diagrams useful in explaining an exemplary mechanism employed in the embodiment for determining the touchdown of the magnetic head; and

FIG. 10 is an example of line graphs representing touchdown points measured in different zones on the magnetic disk, in which the magnetic head is positioned, and touchdown points measured in the zones using prior art.

### DETAILED DESCRIPTION

Various embodiments will be described hereinafter with reference to the accompanying drawings. In general, according to one embodiment, a method of detecting contact of a magnetic head with a magnetic disk by changing the dynamic flying height of the magnetic head in a magnetic disk drive is disclosed. The method can detect a change in the rotational speed of the magnetic disk. The method can detect the contact of the magnetic head with the magnetic disk based on the detected change in the rotational speed.

Firstly, a description will be given of the principle of the mechanism of detecting the touchdown of a magnetic head, employed in the embodiment.

(1) A magnetic disk drive (HDD) according to the embodiment has a function of detecting the touchdown of a magnetic head on a magnetic disk by varying the dynamic flying height of the magnetic head, and setting the flying height of the magnetic head based on the detection result. The first feature of the embodiment lies in that in the above magnetic disk drive, the touchdown of the magnetic head is detected by detecting a change in the rotational speed of the magnetic disk.

Referring now to FIG. 1, the relationship between the touchdown (contact) of the magnetic head and a change in the rotational speed of the magnetic disk will be described. As shown in FIG. 1, when a magnetic head 11 contacts a magnetic disk 12 rotating in the direction indicated by arrow 14, contact stress occurs in the magnetic disk 12, and a contact frictional force 13 corresponding to the stress is exerted on the magnetic head 11. When the contact frictional force 13 is exerted on the magnetic head 11, radial and tangential vibrations of the magnetic disk 12 are exerted on the magnetic head 11. Namely, the contact of the magnetic head 11 to the magnetic disk 12 can be observed as the vibration of the magnetic head 11.

The contact frictional force 13 also adversely affects the magnetic disk 12 to reduce the rotational speed of the magnetic disk 12. In consideration of this, the embodiment employs a method of easily detecting the contact of the magnetic head 11 simply by detecting a change in the rotational speed of the magnetic disk 12.

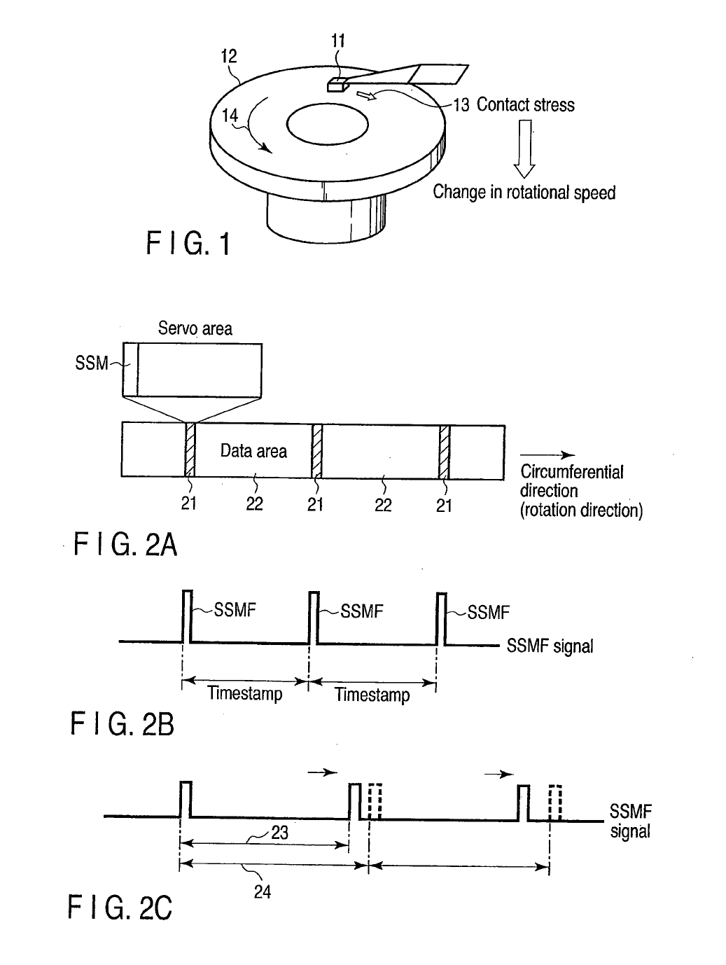

(2) The second feature of the embodiment lies in that the time interval between adjacent servo areas 21 (see FIG. 2A) discretely provided on the magnetic disk 12, i.e., a so-called timestamp (see FIGS. 2B and 2C), is utilized to detect a change in the rotational speed of the magnetic disk 12. The time interval (i.e., the servo time interval) between the adjacent servo areas 21 indicates the time interval required for each servo area 21 to pass the position of the magnetic head 11 shown in FIG. 1 in accordance with the rotation of the magnetic disk 12. By measuring the servo time interval, a change in the rotational speed of the magnetic disk 12 can be easily detected. As will be described later, the servo time interval can be measured as the interval of the times of detecting servo patterns (more specifically, servo synchronization marks) recorded on the servo areas 21.

Recent read channels generally have a function of measuring the servo time interval. This function is prepared to optimize the write frequency for write operation. By this function, a change in the servo time interval is monitored. Therefore, when the magnetic head follows a trajectory eccentric with respect to the servo pattern recorded on the magnetic disk, a change in the servo time interval can be accurately detected. This enables a change in servo acquisition frequency to be predicted beforehand to thereby stabilize the servo control operation. In the embodiment, by diverting the above-mentioned function of the read channels, a change in the rotational speed of the magnetic disk 12 shown in FIG. 1 can be accurately detected.

Referring then to FIGS. 2A, 2B and 2C, a description will be given of an example of a relationship between a change in the rotational speed of the magnetic disk and a change in the servo time interval (timestamp). As shown in FIG. 2A, the servo areas 21 on which servo patterns are recorded are circumferentially discretely provided on the magnetic disk 12 shown in FIG. 1. Data areas 22 are provided between the adjacent servo areas 21. Servo synchronization marks (SSM) as information for identifying the respective servo areas 21 are recorded on predetermined portions, e.g., the leading portions, of the servo areas 21.

When the magnetic head 11 shown in FIG. 1 contacts the magnetic disk 12 to cause the contact frictional force 13 therebetween, a change in the rotational speed of the magnetic disk 12 appears as a change in the time interval (servo time interval) between the adjacent servo areas 21. More specifically, the change in the rotational speed of the magnetic disk 12 appears as a change in the time interval (timestamp) between the times SSMF at which the servo synchronization marks (SSM) are detected (founded), as is shown in FIGS. 2B and 2C. Thus, the change in the rotational speed of the magnetic disk 12 is detected numerically as a timestamp change representing changes in measured timestamp values. In particular, FIG. 2C shows a case where the contact frictional force 13 reduces the rotational speed of the magnetic disk 12, with the result that a timestamp value 23 has changed to a timestamp value 24 higher than the former.

(3) The third feature of the embodiment lies in that the following method of measuring (detecting) a timestamp difference is employed in order to enhance the measurement (detection) accuracy of the timestamp change. In the embodiment, in timestamp difference measurement, the timestamp values detected when the magnetic head 11 and the magnetic disk 12 shown in FIG. 1 are out of contact with each other are used as reference values. In contrast, the timestamp values detected when the magnetic head 11 and the magnetic disk 12 are in contact with each other are used as estimated values.

In the embodiment, over the period of acquiring the timestamp values, the difference between the reference value and the estimated value is measured (calculated) as a timestamp difference at every SSMF at which the same servo area 21 is detected. As a result, a timestamp difference change representing changes in the timestamp differences is measured. Based on the timestamp difference change, contact between the magnetic head 11 and the magnetic disk 12 can be accurately detected.

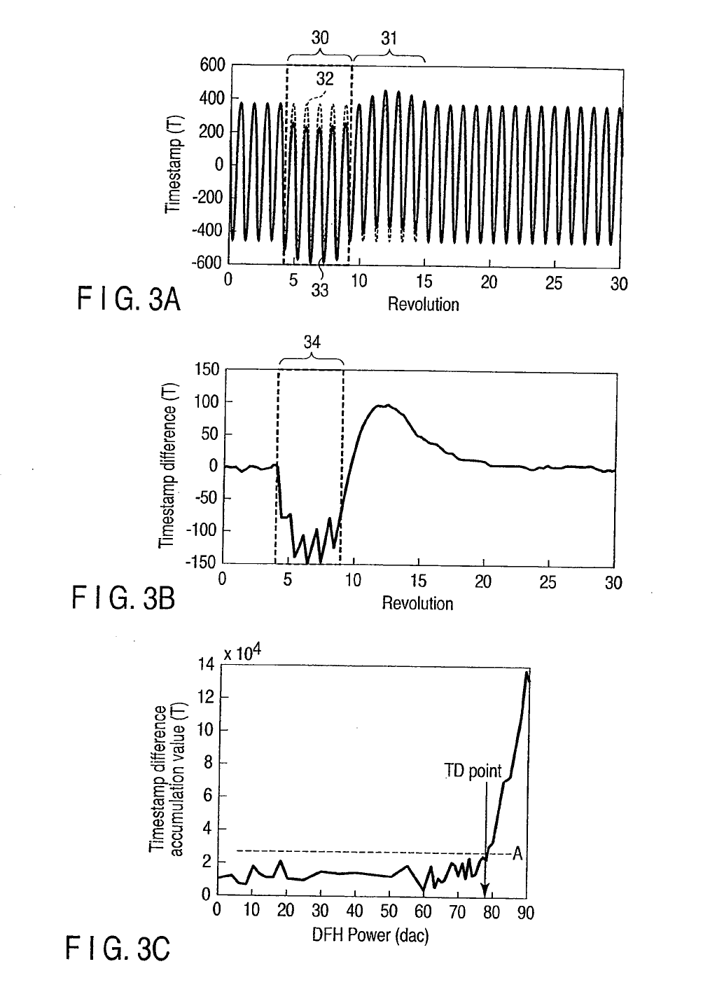

Referring to FIGS. 3A, 3B and 3C, the timestamp difference change will be described. In the embodiment, assume that the timestamp values are acquired (detected) only in a predetermined period, e.g., a period in which the magnetic disk 12 makes a predetermined number of revolutions (30 revolutions in the embodiment). Namely, in the embodiment, the timestamp values detected in the period, in which the magnetic head 11 and the magnetic disk 12 are in a non-touchdown state (non-TD state) where they are out of contact with each other, and in which the magnetic disk 12 makes 30 revolutions, are acquired as reference values.

Subsequently, DFH power supplied to the aforementioned heating element is gradually increased. As a result, the dynamic flying height of the magnetic head 11 is gradually reduced. Whenever the DFH power is increased, the timestamp values detected in the period, in which the magnetic disk 12 makes 30 revolutions, are acquired as estimated values.

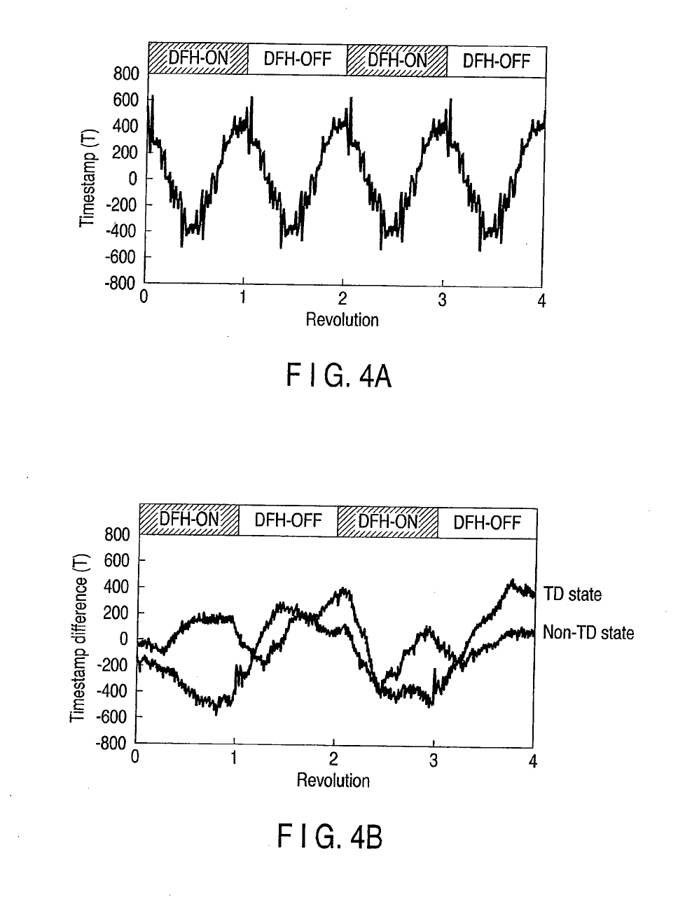

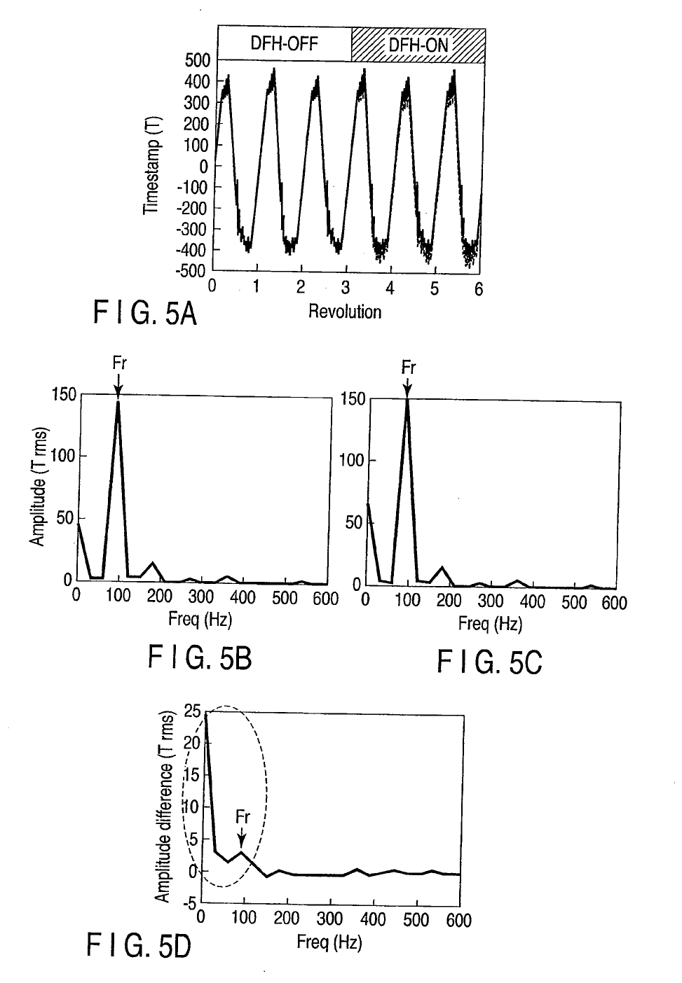

The broken line 32 in FIG. 3A indicates an example of a curve representing, as a timestamp change, changes in timestamp values (reference values) assumed in the period, in which the magnetic head 11 and the magnetic disk 12 are in a non-touchdown state (non-TD state) where they are out of contact with each other, and the magnetic disk 12 makes 30 revolutions. The solid line 33 in FIG. 3A indicates an example of a curve representing, as a timestamp change, changes in timestamp values (estimated values) assumed in the period, in which the magnetic head 11 and the magnetic disk 12 are in a touchdown state (TD state) where they are in contact with each other, and the magnetic disk 12 makes 30 revolutions. However, note that in FIG. 3A, the timestamp values are normalized so that when a change in timestamp value (reference value) is 0, the timestamp values assume 0. The same can be said of FIGS. 4A and 5A referred to later.

In the example of FIG. 3A, the magnetic head 11 and the magnetic disk 12 actually contact each other during a period 30 corresponding to five revolutions of the disk 12 ranging from the fourth revolution to the ninth revolution. Further, in this example, since the contact between the magnetic head 11 and the magnetic disk 12 reduces the rotational speed of the magnetic disk 12, control for returning the rotational speed to a reference speed is executed. As a result of this control, in a period 31 ranging from the ninth revolution to the 15^{th} revolution, the timestamp is changed to increase, compared to the period 30.

In the embodiment, as shown in FIG. 3A, the difference between the reference value and the estimated value is calculated at every SSMF at which the same servo area 21 is detected. As a result, such a timestamp difference curve as shown in FIG. 3B can be acquired. In the example of FIG. 3B, the magnetic head 11 and the magnetic disk 12 actually contact each other during a period 34 corresponding to five revolutions of the disk 12 ranging from the fourth revolution to the ninth revolution. The period 34 corresponds to the period 30 in FIG. 3A.

Such a timestamp difference curve as shown in FIG. 3B is obtained for each level of the DFH power supplied to the heating element. In the embodiment, the accumulation value of the timestamp differences is calculated for each DFH power level over a predetermined number of revolutions.

FIG. 3C shows an example of a curve representing accumulation values of timestamp differences corresponding to respective DFH power levels. In the example of FIG. 3C, a value (dac value) set in a digital-to-analog converter (DAC) for determining DFH power is used as the DFH power.

FIG. 3C illustrates that when the magnetic head 11 and the magnetic disk 12 contact each other, the timestamp difference varies as shown in FIG. 3B, whereby the accumulation value of the timestamp differences varies. In FIG. 3C, the DFH power (dac value), at which the accumulation value of the timestamp differences exceeds a threshold value A, indicates the lowest DFH power required for the touchdown of the magnetic head 11 on the magnetic disk 12. This lowest DFH power is called a touchdown point (TD point).

The acquisition of the timestamp differences will involve the advantage described below. Assume here that periodical change will occur in the revolution of the magnetic disk 12. The change in revolution appears as a timestamp change. In view of this, in the embodiment, the reference values are measured at the first half of a predetermined number of revolutions, and the estimated values are measured at the latter half, with the magnetic head 11 and the magnetic disk 12 kept in contact with each other. The difference between the reference value and the estimated value at every SSMF of the same servo area 21, namely, the timestamp difference, is calculated. The periodical rotational change component is eliminated from the timestamp difference. Namely, the timestamp difference contains no periodical rotational change component. This enhances the detection accuracy of timestamp values.

(4) The fourth feature of the embodiment lies in that the measurement of the timestamps as the third feature is executed by periodically alternating the state in which the dynamic flying height of the magnetic head 11 is controlled, and the state in which the dynamic flying height is not controlled. In the embodiment, the state in which the dynamic flying height is controlled, and the state in which the dynamic flying height is not controlled, are switched per a certain number of revolutions of the magnetic disk 12 or per a certain number of servo sectors. By calculating (measuring) the difference between the timestamps (timestamp difference), contact between the magnetic head 11 and the magnetic disk 12 is detected. The state in which the dynamic flying height is controlled is the state in which DFH power is supplied to the heating element (i.e., the DFH-ON state), while the state in which the dynamic flying height is not controlled is the state in which DFH power is not supplied to the heating element (i.e., the DFH-OFF state).

FIG. 4A shows an example of a curve representing a timestamp change measured when the DFH-ON state and the DFH-OFF state are alternated per one revolution of the magnetic disk 12. FIG. 4B shows an example of timestamp difference change curves assumed in the touchdown state (TD state) and the non-touchdown state (non-TD state). Changes in the timestamp differences represented by the curves are measured when the DFH-ON state and the DFH-OFF state are alternated per one revolution of the magnetic disk 12.

In the case of FIG. 4A, only when the magnetic disk 12 makes odd-numbered revolutions, it assumes the DFH-ON state and its dynamic flying height is controlled. Namely, only when the magnetic disk 12 revolves odd numbers of times, touchdown of the magnetic head 11 on the magnetic disk 12 is attempted. In this case, by comparing the timestamp measurement result during odd-numbered revolutions with the timestamp measurement result during even-numbered revolutions, a timestamp change can be detected.

In practice, a magnetic disk of a small diameter, such as 1.8 inches, which has a smaller inertia than a magnetic disk of 2.5 inches, may well produce significant irregular rotational fluctuation. In this magnetic disk, when a frictional force occurs between the magnetic head and the magnetic disk, a timestamp change is relatively small, which results in the degradation of the performance of detecting the timestamp change.

In the embodiment, to suppress reduction of the performing of detecting the timestamp change, the dynamic flying height of the magnetic head 11 is periodically controlled as shown in FIGS. 4A and 4B. In each period synchronized with the period of flying height control, a timestamp is acquired. The difference between the timestamp acquired during the flying height control and that acquired during no flying height control is calculated (measured) at every SSMF of the same servo area 21.

By calculating the timestamp difference, the rotation change component of the magnetic disk 12 is canceled. Thus, only the timestamp change caused by the contact of the magnetic head 11 with the magnetic disk 12 can be extracted, thereby enhancing the accuracy of measurement.

(5) The fifth feature of the embodiment lies in that in the timestamp measurement characterized by the above-mentioned second to fourth features, after timestamps are measured over a period corresponding to a predetermined number of revolutions, particular frequency components are extracted based on the measurement results. Specifically, the particular frequency components are extracted by subjecting the measured timestamp values to fast Fourier transform (FFT).

The fifth feature of the embodiment also lies in that the value obtained by the above-mentioned FFT in the non-TD state where the magnetic head 11 and the magnetic disk 12 do not contact each other is used as a reference value, and the value obtained by the above-mentioned FFT in the TD state where the magnetic head 11 and the magnetic disk 12 contact each other is used as an estimated value, thereby calculating (measuring) the difference therebetween for each frequency component to detect whether the magnetic head 11 and the magnetic disk 12 contact each other.

FIG. 5A shows an example of a curve representing a timestamp change that occurs in the embodiment when the DFH-OFF state (DFH-OFF period) in which the dynamic flying height of the magnetic head is not controlled, and the DFH-ON state (DFH-ON period) in which the dynamic flying height of the magnetic head is controlled are set successively. Further, FIG. 5B shows an example of a curve representing timestamp frequency characteristic values (frequency spectra) as FFT results obtained in the DFH-OFF state, and FIG. 5C shows an example of a curve representing timestamp frequency characteristic values (frequency spectra) as FFT results obtained in the DFH-ON state.

As shown in FIGS. 5B and 5C, each of the particular frequency components extracted by FFT is a frequency component that exhibits a relatively long period of the timestamp change due to contact between the magnetic head 11 and the magnetic disk 12, and has a lower frequency than the revolution frequency Fr of the magnetic disk 12. Thus, by calculating the differences between the frequency characteristic values of timestamps obtained when the magnetic head 11 and the magnetic disk 12 are out of contact, and those of timestamps obtained when they are in contact with each other, the difference therebetween can be confirmed with a lower frequency component than the revolution frequency Fr.

FIG. 5D shows an example of a curve of a timestamp difference change representing changes in differences between the timestamp frequency characteristic values shown in FIGS. 5B and 5C. As is evident from FIG. 5D, by calculating the differences between the timestamp frequency characteristic values shown in FIGS. 5B and 5C, the revolution frequency Fr component is canceled. Thus, head contact detection with a high signal-to-noise ratio (S/N ratio) can be realized. Note that in the embodiment, the rotational speed of the magnetic disk 12 is set to 5400 rpm, and the revolution frequency Fr is 90 Hz. In FIGS. 5B to 5D, the vertical axis indicates the root-mean-square (rms) of the intensity (amplitude) of the frequency component.

Alternatively, when the magnetic head 11 is made to contact the magnetic disk 12 by periodically controlling the dynamic flying height of the magnetic head 11, a frequency component corresponding to the period of control (=the period corresponding to three revolutions in the example of FIG. 5A) may be extracted. This enhances the performance of detection as in the above case.

(6) The sixth feature of the embodiment lies in that when in magnetic disk drives, the quality of, for example, a read or write signal is reduced to a level lower than a reference level, the above-described methods are applied to detect contact between the magnetic head 11 and the magnetic disk 12. The sixth feature of the embodiment also lies in that in the adjusting/checking process of magnetic disk drives, the above-described methods are applied to detect contact between the magnetic head 11 and the magnetic disk 12. In this case, during the adjusting/checking process of magnetic disk drives, the touchdown of the magnetic head 11 can be accurately detected to thereby accurately correct the dynamic flying height of the magnetic head 11. As a result, the magnetic spacing between the magnetic head 11 and the magnetic disk 12 can be accurately held. This enables the read/write signals of the magnetic disk drives to be kept at high quality, which enhances the yield and quality of products.

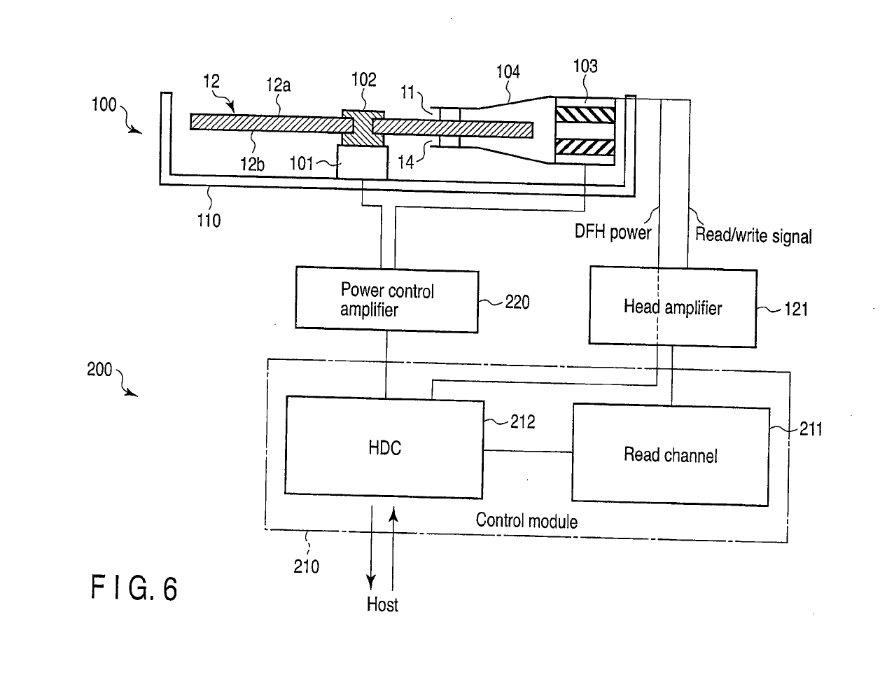

The embodiment, to which the above-mentioned principle is applied, will be described in detail. FIG. 6 shows the structure of the magnetic disk drive of the embodiment. In FIG. 6, elements equivalent to those of FIG. 1 are denoted by corresponding reference numbers, and no detailed description will be given thereof. The magnetic disk drive shown in FIG. 6 mainly comprises a head disk assembly unit (HDA unit) 100, and a printed circuit board unit (PCB unit) 200.

The HDA unit 100 comprises a spindle motor 101, a hub 102 and a voice coil motor (VCM) driving mechanism 103, as well as the magnetic head 11 and the magnetic disk 12. The HDA unit 100 is incorporated in, for example, a rectangular aluminum housing 110 with an upper opening. The upper opening of the housing 110 is covered with a shield member and a top plate, which are not shown, so that the HDA unit 100 is isolated from the external air.

In the HDA unit 100, the magnetic disk 12 is attached to the spindle motor 101 via the hub 102 and is rotated at a predetermined rotational speed (e.g., 5400 rpm). The surfaces 12a and 12b of the magnetic disk 12 serve as recording surfaces on which data is magnetically recorded. The magnetic head 11 is provided close to the surface 12a of the magnetic disk 12.

The spindle motor 101 is controlled by a control module 210, described later. The control for the spindle motor 101 includes control for maintaining the spindle motor 101 at a predetermined rotational speed, and control for starting/stopping the spindle motor 101. The VCM driving mechanism 103 is also controlled by the control module 210. In accordance with instructions from the control module 210, the VCM driving mechanism 103 loads the magnetic head 11 onto the magnetic disk 12, unloads the same from the disk 12, and executes a seek operation of moving the magnetic head 11 to a target track on the magnetic disk 12. The VCM driving mechanism 103 includes a VCM (voice coil motor), and executes the seek operation by controlling the angular movement of an actuator 104 with the magnetic head 11 mounted thereon.

In the magnetic disk drive of FIG. 6, another magnetic head 14 is provided close to the surface 12b of the magnetic disk 12. However, for simplifying the description, the magnetic head 14 will not be described. However, if necessary, in the description below, the magnetic head 11 may be replaced with the magnetic head 14.

In the HDA unit 100, a head amplifier 121 is provided on a flexible printed circuit board (FPC) that is located near the VCM driving mechanism 103. The head amplifier 121 is electrically connected to the magnetic head 11 and the control module 210 via the FPC. However, in FIG. 1, the head amplifier 121 is drawn away from the VCM driving mechanism 103 for convenience of drawing. The head amplifier 121 may be mounted on the actuator 104, or be provided on the PCB unit 200.

The head amplifier 121 comprises a read amplifier, a write driver and a power amplifier, which are not shown. The read amplifier amplifies a signal (read signal) read by the head 121. The write driver converts, into a write current (write signal), write data transferred from a read channel 211, described later, and outputs the same to the magnetic head 11. The power amplifier supplies a heating element incorporated in the magnetic head 11 with power (i.e., DFH power) for controlling the dynamic flying height of the magnetic head 11, in accordance with an instruction from a disk controller 212, described later.

The PCB unit 200 comprises a control module 210 and a power control amplifier 220. The control module 210 and the power control amplifier 220 are mounted on a printed circuit board, not shown. The control module 210 comprises a read channel (RDC) 211 and a disk controller (hereinafter, HDC) 212. The read channel 211 executes signal processing associated with read/write. Namely, the read channel 211 converts, into digital data, a read signal amplified by the head amplifier 121, and decodes read data from the digital data. The read channel 211 extracts servo data (servo pattern) from the digital data. The read channel 211 encodes write data transferred from the HDC 212, and transfers the encoded write data to the head amplifier 121. Further, the read channel 211 has a function of monitoring the aforementioned timestamp values. The HDC 212 transmits and receives signals to and from a host via an external interface. More specifically, the HDC 212 receives commands (write and read commands, etc.) transferred from the host via the external interface. The HDC 212 controls data transfer between the host and the HDC itself. The HDC 212 generates write data in accordance with a data signal transferred from the host via the external interface. The HDC 212 controls data transfer executed between the HDC itself and the magnetic disk 12 via the read channel 211. The HDC 212 controls the spindle motor 101, the VCM driving mechanism 103, etc. In the embodiment, control signals for controlling the spindle motor 101 and the VCM driving mechanism 103 are generated by the power control amplifier 220 under the control of the HDC 212. The HDC 212 supplies DFH power to the heating element, incorporated in the magnetic head 11, via the head amplifier 121.

In accordance with recent tendency of high recording density in magnetic disk drives, magnetic marks recorded on magnetic disks are more and more reduced in size. To realize high recording density, it is necessary to reduce the magnetic spacing between the magnetic disk and the magnetic head. To this end, the magnetic head incorporates a heating element, and each of the magnetic disk drives controls the DFH power to the heating element to thereby adjust the dynamic flying height of the magnetic head. Namely, in each of the magnetic disk drives, the thermal expansion of the magnetic head is controlled to adjust the amount of projection of the read/write element of the magnetic head, thereby adjusting the dynamic flying height of the magnetic head to a predetermined value. Also in the magnetic disk drive shown in FIG. 6, the magnetic head 11 includes the heating element, and the dynamic flying height of the magnetic head 11 is controlled by controlling the DFH power supplied from the head amplifier 121 to the heating element, using the control module 210.

In general, if no DFH power is supplied, the magnetic heads of different magnetic disks have different dynamic flying heights. Further, when a magnetic disk drive incorporates a plurality of magnetic heads, these magnetic heads also generally exhibit different dynamic flying heights if no DFH power is supplied. In light of this, to correct the dynamic flying height of each magnetic head, said each magnetic head is brought into contact with a corresponding magnetic disk to detect a state in which its dynamic flying height is zero.

In the prior art, the state in which the dynamic flying height of the magnetic head is zero, i.e., in which the magnetic head contacts the magnetic disk, is detected using a track position error signal (PES), as is mentioned before. However, it is difficult to detect the touchdown of the magnetic head using the PES, for the following reasons:

The magnetic head is swung by the rotary pivot of the VCM driving mechanism to trace an arc with respect to the magnetic disk. In this case, a certain angle (so-called skew angle) is inevitably formed between the position of the magnetic head on the inner circumferential portion of the magnetic disk and that of the magnetic head on the outer circumferential portion of the same, with respect to the direction of revolution (i.e., along the circumference) of the disk. Accordingly, when the magnetic head contacts the magnetic disk, a contact frictional force will occur therebetween to thereby produce drag force components in the circumferential and radial directions of the magnetic disk.

At this time, the positioning control of settling the magnetic head to a target track on the magnetic disk against the radial drag force component is executed. However, because of the influence of, for example, vibration (swing) that occurs when the magnetic head contacts the magnetic disk, the magnetic head cannot be reliably settled on the target track. As a result, the amplitude (hereinafter, referred to as the “PES value”) of the PES is increased. In the prior art, touchdown is detected by detecting an increase in the PES value.

However, when the target track is in the radially middle portion of the magnetic disk, i.e., when the magnetic head is positioned on a target track situated in the radially middle portion of the magnetic disk, the direction in which the contact frictional force acts coincides with that in which the drag force of the magnetic head acts, and hence the radial swing of the magnetic head is small. In this case, a change in radial deviation of the magnetic head from the target track is hard to appear, and little change is found in the PES value. This makes it difficult to detect touchdown of the magnetic head.

In view of this, the embodiment employs the above-described method of detecting a change in the rotational speed of the magnetic disk 12 caused by the contact frictional force 13 (see FIG. 1) that occurs when the magnetic head 11 contacts the magnetic disk 12, thereby detecting touchdown of the magnetic head 11. Further, the embodiment uses timestamp values to quantitatively detect a change in the rotational speed of the magnetic disk 12 (see FIGS. 2A, 2B and 2C).

As aforementioned, the timestamp values indicate time intervals at which the servo areas 21 on the magnetic disk 12 pass the magnetic head 11 in accordance with the rotation of the magnetic disk 12. In the embodiment, the values obtained by measuring the SSMF intervals of an SSMF signal that indicate the detection times of the servo synchronization marks (SSM) recorded on the servo areas 21 are used as the timestamp values.

The read channel 211 monitors the timestamp values during a servo operation for positioning the magnetic head 11 on a target track on the magnetic disk 12, and during a write operation for writing data to the magnetic disk 12. The monitored timestamp values obtained during the servo operation and during the write operation are used for adjusting the servo acquisition frequency and the write lock frequency, respectively.

The servo areas 21 on the magnetic disk 12, on which the servo patterns are recorded, are not concentrically but are eccentrically positioned with respect to the magnetic head 11. This is because the magnetic disk 12 is rotated at different centers of rotation between a servo track writer for discretely recording the servo patterns on the magnetic disk 12, and the magnetic disk drive provided with the magnetic disk 12 with the servo patterns recorded thereon.

Accordingly, different circumferential speeds are detected at different servo patterns (servo areas 21) in accordance with the degrees of eccentricity. This may well cause a change in the servo acquisition frequency and result in degradation of the stability of the servo operation. To avoid this, the read channel 211 monitors the timestamp values to detect a change in the rotational speed of the magnetic disk 12 and stabilize the servo acquisition frequency based on the detected change.

In the embodiment, the timestamp values monitored by the read channel 211 are used to detect touchdown of the magnetic head 11. Namely, the embodiment employs a method of observing a timestamp change to detect a change in the rotational speed of the magnetic disk 12 due to the touchdown of the magnetic head 11.

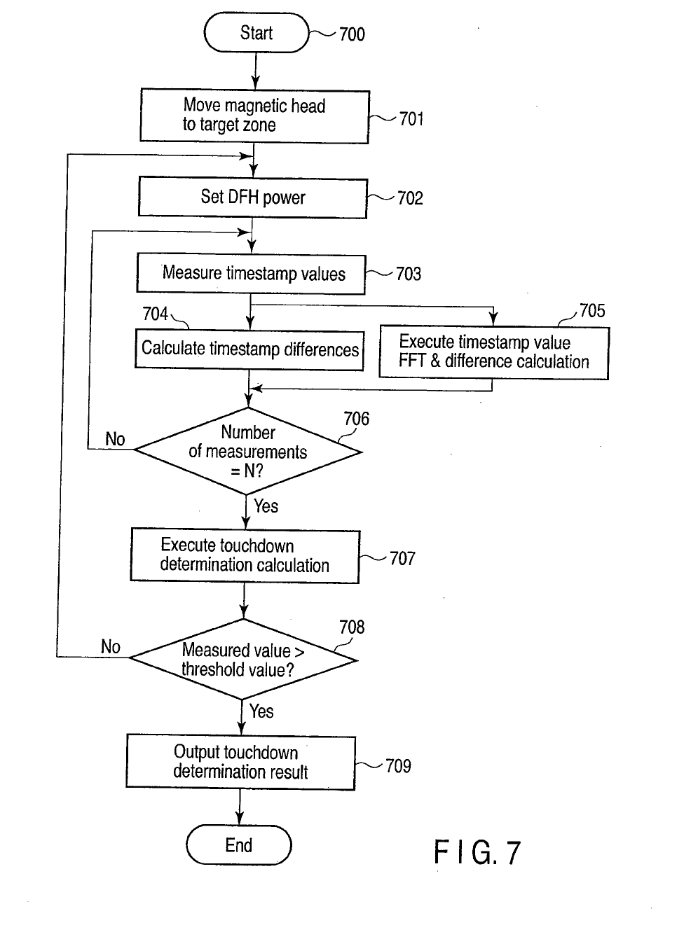

Referring then to the flowchart of FIG. 7, a description will be given of a procedure of measuring (detecting) touchdown employed in the embodiment, using, as an example, touchdown measurement in an adjusting/checking process performed when shipping such magnetic disks as shown in FIG. 6. Assume here that the HDC 212 has received a measurement command from the host. The HDC 212 starts touchdown measurement (block 700). Firstly, the HDC 212 controls the VCM driving mechanism 13 via the power control amplifier 220 to move the magnetic head 11 to a target zone on the magnetic disk 12 (block 701). In the embodiment, the magnetic disk 12 is divided, for management, into a plurality of radial zones. Assume here that touchdown is measured in each of the radially inner, middle and outer zones of the magnetic disk 12. However, the number of zones as measurement targets is not limited to three. For instance, if the flying height characteristic of the magnetic head 11 is varied at radial positions on the magnetic disk 12 by a design of the air bearing surface (ABS) of the magnetic head 11, the number of target zones may be increased for detailed checking.

Subsequently, to control the dynamic flying height of the magnetic head 11 to detect touchdown thereof, the HDC 212 functions as a dynamic flying height control module and sets DFH power supplied to the heating element incorporated in the magnetic head 11 (block 702). Namely, the HDC 212 sets, in the head amplifier 121, a parameter (DFH power parameter) for designating DFH power to be supplied to the heating element. As a result, the head amplifier 121 supplies the set DFH power to the heating element for a “DFH-ON” period in which the supply of the DFH power is designated by the HDC 212.

Whenever the block 702 is executed, the HDC 212 changes the DFH power. In the head amplifier 121, the maximum DFH power that can be supplied to the heating element is divided into 256-step values indicated by 8-bit data. Thus, the DFH power is gradually varied (increased) per so-called dac (=a unit of resolution). By thus varying the DFH power, the thermal expansion of the magnetic head 11 is varied. As a result, the amount of projection of the read/write element of the magnetic head 11 is varied to thereby vary the dynamic flying height of the magnetic head 11.

After that, the HDC 212 functions as a timestamp measuring module, and measures timestamp values using, for example, the read channel 211 by providing the read channel 211 with an instruction to acquire the timestamp values (block 703). In the embodiment, the timestamp value measurement is performed during a period corresponding to a second number of revolutions of the magnetic disk 12. The period of the second number of revolutions follows a period corresponding to a first number of revolutions of the magnetic disk 12. The HDC 212 instructs the head amplifier 121 to supply no DFH power during the period of the first number of revolutions, and to supply DFH power during the period of the second number of revolutions. The first number of revolutions is equal to the second number of revolutions.

Thereafter, the HDC 212 functions as a first detector (first detection module) and calculates changes in the timestamp values. In the embodiment, the changes in the timestamp values are calculated by two methods. Firstly, the HDC 212 calculates, at every SSMF of the same servo area 21, the difference (timestamp difference) between the timestamp value (hereinafter, referred to as “the first timestamp value”) obtained in the DFH-OFF state in which no DFH power is supplied to the heating element, and the timestamp value (hereinafter, referred to as “the second timestamp value”) obtained in the DFH-ON state in which DFH power is supplied to the heating element (block 704).

Further, the HDC 212 functions as a FFT & difference calculation module and executes timestamp value FFT & difference calculation (block 705), in parallel with the difference calculation at block 704. More specifically, the HDC 212 executes FFT on the first timestamp value and the second timestamp value to calculate, for each particular frequency, the difference between the FFT operation value of the first timestamp value (hereinafter, referred to as “the first FFT operation value”) and the FFT operation value of the second timestamp value (hereinafter, referred to as “the second FFT operation value”).

At the next block 706, the HDC 212 determines whether the number of timestamp value measurements reaches a predetermined number N. If the predetermined number N is not reached (No at block 706), blocks 703 to 705 are executed again.

If the predetermined number N is reached (Yes at block 706), the HDC 212 determines that measurement data necessary for touchdown determination (detection) has been acquired. At this time, the HDC 212 functions as a second detector (second detection module) and performs calculation (touchdown determination calculation) to acquire data used for touchdown determination (block 707). More specifically, the HDC 212 averages difference calculation results corresponding to the respective N-time measurement results for the currently set DFH power (current DFH power), thereby acquiring a timestamp difference value corresponding to the current DFH power.

At the next block 708, the HDC 212 determines whether the timestamp difference value (measured value) exceeds a threshold value set for touchdown determination. If the threshold value is not exceeded (No at block 708), the HDC 212 returns to block 702. At block 702, the HDC 212 increments, by 1 dac, the DFH power to be supplied to the heating element by the head amplifier 121, in order to reduce the dynamic flying height of the magnetic head 11 to a value lower than the current value. After that, the HDC 212 proceeds to block 703, where it restarts timestamp measurement.

In contrast, if the timestamp difference value exceeds the threshold value (Yes at block 708), the HDC 212 reports, to the host, the current DFH power, i.e., the DFH power with which the timestamp change value exceeds the threshold value, as the DFH power for bringing the magnetic head 11 into contact with the magnetic disk 12 (i.e., as touchdown determination result) (block 709), thereby terminating the touchdown measurement.

Based on the DFH power reported from the HDC 212 as the power for touchdown of the magnetic head 11, the host determines DFH power for adjusting the dynamic flying height of the magnetic head 11 to a predetermined value. The host set, in, for example, a flash ROM (i.e., rewritable nonvolatile memory), not shown, in the HDC 212, a DFH power parameter for designating the determined DFH power in association with the magnetic head 11. As a result, the HDC 212 can highly accurately adjust the dynamic flying height of the magnetic head 11 to the predetermined value in a read/write period, based on the DFH power parameter set in the flash memory in association with the magnetic head 11. The HDC 212 can also execute such DFH power correction as the above for adjusting the dynamic flying height of the magnetic head 11 to the predetermined value, independently of the host, even after the shipping of the magnetic disk drive, if the quality of a read or write signal becomes lower than a reference level.

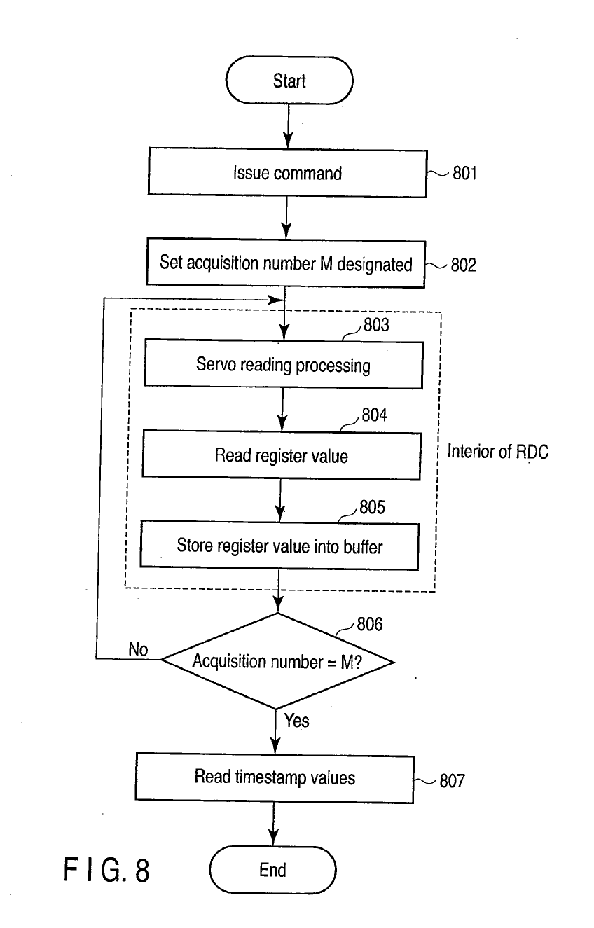

Blocks 703 to 705, 707 and 708 included in the above-described touchdown measurement will now be described in more detail. Referring first to the flowchart of FIG. 8, a detailed description will be given of the procedure of the timestamp value measurement executed at block 703. Firstly, the HDC 212 issues, to the read channel 211, a timestamp value acquisition command for acquire timestamp values (block 801). The timestamp value acquisition command includes an acquisition number M of timestamp values as a parameter. When the timestamp value acquisition command is issued, the HDC 212 sets, in the read channel 211, the acquisition number M of timestamp values designated by the command (block 802).

In the fundamental timestamp acquisition method employed in the embodiment, it is necessary to acquire timestamp values corresponding to a predetermined number R of revolutions. In this case, supposing that the number of servo areas 21 (i.e., the number of servo sectors) passed by the magnetic head 11 while the magnetic disk 12 makes one revolution is S, acquisition of R×S (=M) timestamp values is designated. In the examples of FIGS. 4A and 5A, R is 4 and 6, respectively, and hence M is 4×S and 6×S, respectively. The predetermined number R of revolutions may be designated instead of the acquisition number M.

When the designated acquisition number M is set in the read channel 211, the read channel 211 starts measurement of timestamp values designed by the timestamp value acquisition command in accordance with a firmware program. At this time, servo reading processing (block 803) for reading a servo pattern recorded on each servo area 21 is executed. The firmware program is stored in a nonvolatile memory, such as a ROM or a flash ROM, incorporated in the magnetic disk drive shown in FIG. 6.

In servo reading processing, servo synchronization marks (SSM) are detected. Specifically, in servo reading processing, the read channel 211 measures the interval, i.e., a timestamp value, between the detection time of the current servo synchronization mark and the servo synchronization mark detection time in the preceding servo reading processing. The read channel 211 temporarily holds the measured timestamp value in a predetermined register therein.

After completing the servo reading processing, the read channel 211 reads the timestamp value (register value) held by the predetermined register (block 804), and stores the value in, for example, a first-in first-out buffer, not shown, incorporated therein (block 805). At this time, the read channel 211 reports the completion of one-time servo reading to the HDC 212.

The HDC 212 counts the number of times of completed servo reading informed by the read channel 211, thereby counting the number of timestamp values stored in the buffer of the read channel 211, namely, the timestamp value acquisition number. Whenever completion of servo reading is reported by the read channel 211, the HDC 212 determines whether the timestamp value acquisition number reaches the designated acquisition number M (block 806).

If the timestamp value acquisition number does not reach M (No at block 806), the HDC 212 instructs the read channel 211 to re-execute the above-described operations (blocks 803 to 805). Thus, the HDC 212 controls the iteration of the operations in blocks 803 to 805 by the read channel 211 until the timestamp value acquisition number reaches M. If the timestamp value acquisition number has reached M (Yes at block 806), the HDC 212 reads the same number of timestamp values as the number M from the buffer in a time-series manner (block 807). As a result, the HDC 212 acquires the same number of timestamp values as the acquisition number M designated for the read channel 211.

First through third methods can be used to acquire timestamp values. The first method is a method of acquiring timestamp values by varying DFH power a certain number of times corresponding to the number of revolutions measured. The second method is a method of acquiring timestamp values by combining the revolutions in which no DFH power is supplied, and the revolutions in which DFH power is supplied, as is shown in FIG. 5A. The third method is a method of acquiring timestamp values by periodically iterating the DFH-ON state and the DFH-OFF state as shown in FIG. 4A.

An appropriate one of the above-mentioned three methods may be selected in consideration of the structure of the magnetic disk drive shown in FIG. 6, the inertia force of the magnetic disk 12, and the like. For instance, in a magnetic disk drive incorporating a 1.8-inch magnetic disk having a small inertia force, the magnetic disk may exhibit large revolution fluctuation. In this case, the revolution fluctuation serves as a noise component for the timestamp change, which may result in a reduction of detection accuracy. At this time, by periodically supplying DFH power and acquiring timestamp values in synchronism with the periods of the DFH power supply, the timestamp change representing the changes in the timestamp values can be accurately detected. In the example shown in FIG. 4A, the DFH-ON state and the DFH-OFF state are alternated per one revolution, and signals that synchronize with the states are acquired to thereby detect the timestamp values.

A description will now be given of the timestamp difference calculation executed at block 704. After finishing the timestamp value measurement using the read channel 211, i.e., after acquiring timestamp values measured by the read channel 211, the HDC 212 calculates timestamp differences. FIG. 3B shows an example of the result of the difference calculation. In the example of FIG. 3B, the timestamp values measured when the number R of revolutions of the magnetic disk 12 is 30 (i.e., measured until the magnetic disk 12 makes thirty revolutions) (see FIG. 3A) are used for difference calculation. However, it is sufficient if timestamp values corresponding to several revolutions are acquired, although the required number of timestamp values depends on the characteristics of the magnetic disk drive.

As described above, FIG. 3A shows the timestamp change that occurs when the magnetic head 11 is in the touchdown (TD) state. As is evident from FIG. 3A, in the non-TD state in which the magnetic head 11 is out of contact with the magnetic disk 12, the timestamp values vary in accordance with the degrees of eccentricity of the magnetic disk 12 to draw a sine curve. These timestamp values will hereinafter be referred to as “the first timestamp values.” In this state, if the magnetic head 11 is brought into contact with the magnetic disk 12, the timestamp values vary from the first timestamp values. The varied timestamp values will hereinafter be referred to as “the second timestamp values.” It should be noted that the first and second timestamp values also reflect the influence of the eccentricity of the magnetic disk 12.

The HDC 212 calculates the difference between the first and second timestamp values at every SSMF of the same servo area 21. FIG. 3B shows the result of the difference calculation, i.e., timestamp differences. By the difference calculation, the influence of the eccentricity of the magnetic disk 12 can be offset, thereby enabling only the timestamp change to be extracted.

The timestamp value FFT operation & difference calculation executed at block 705 will be described. As described above, in the embodiment, the timestamp value FFT operation & difference calculation is executed in parallel with the process of block 704 (timestamp difference calculation). The HDC 212 calculates the first FFT operation values of the timestamp values in the DFH-OFF state, and the second FFT operation values of the timestamp values in the DFH-ON state. After that, the HDC 212 calculates the differences between the first and second FFT operation values (more specifically, the difference per each particular frequency). Based on the difference calculation results, the HDC 212 can detect the timestamp change.

FIG. 5A shows a curve representing the timestamp change in the DFH-OFF state and the DFH-ON state. FIGS. 5B and 5C show the results (frequency spectra) of FFT executed on the timestamp values obtained in the DFH-OFF state and the DFH-ON state, namely, the first and second FFT operations values. In the embodiment in which the rotational speed of the magnetic disk 12 is 5400 rmp, a peak appears at a revolution frequency Fr (90 Hz in this case). Further, since the timestamp change due to touchdown of the magnetic head 11 is a temporally slow change, it is detected as a frequency signal close to a direct current (DC) component.

In light of the above, the HDC 212 calculates, for each particular frequency, the difference (FFT operation value difference) between the first FFT operation value obtained in the DFH-OFF state and the second FFT operation value obtained in the DFH-ON state. FIG. 5D shows a curve representing calculated FFT operation value differences. It should be noted that the difference calculation results show that there are differences in DC component between the first FFT operation values obtained in the DFH-OFF state and the second FFT operation values obtained in the DFH-ON state. Namely, the HDC 212 can extract change in only the low-frequency component of the timestamp values by FFT operation value difference calculation. Further, even if a high-frequency (higher than the revolution frequency Fr of the magnetic head 11) component exists as disturbance noise, it can easily be offset by the calculation of the FFT operation value difference, which leads to enhancement of the measurement accuracy. The amplitude of the high-frequency component, which is included in the frequency components contained in the calculation results of the FFT operation value differences, and is higher than the revolution frequency Fr, is as small as can be ignored.

A description will be given of the touchdown determination calculation executed at block 707, and the touchdown determination executed at block 708. The HDC 212 averages, for each DFH power level, the difference calculation results obtained at block 704 corresponding to N measurement results, thereby acquiring first timestamp difference values. Similarly, the HDC 212 averages, for each DFH power level, the difference calculation results obtained at block 705 and corresponding to N measurement results, thereby acquiring second timestamp difference values.

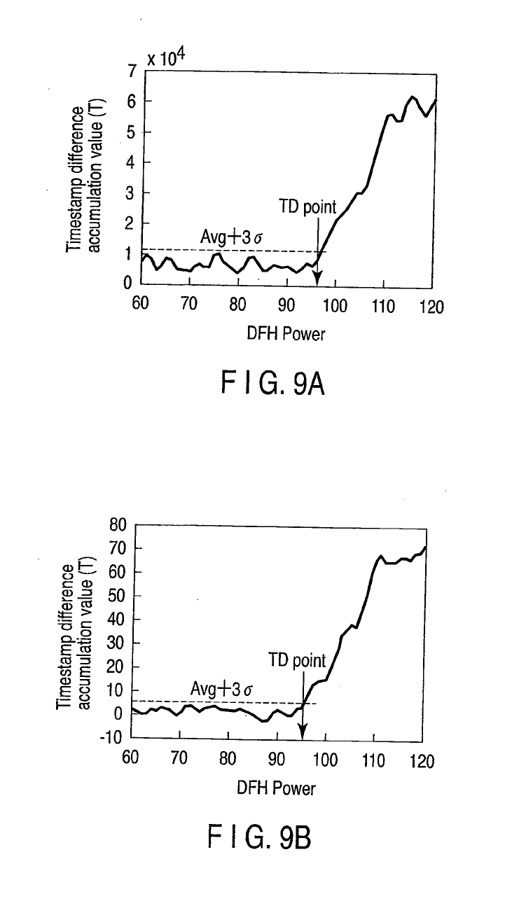

The HDC 212 accumulates the first timestamp difference values acquired at each DFH power level, and accumulates the second timestamp difference values acquired at each DFH power level. FIGS. 9A and 9B show an example of the accumulation result (first timestamp accumulation value) of the first timestamp difference values acquired at each DFH power level, and an example of the accumulation result (second timestamp accumulation value) of the second timestamp difference values acquired at each DFH power level, respectively.

As is evident from FIGS. 9A and 9B, when the DFH power is low and hence the magnetic head 11 is out of contact with the magnetic disk 12 (non-TD state), changes in the first and second timestamp difference accumulation values are small, while when the DFH power becomes high and hence the magnetic head 11 is brought into contact with the magnetic disk 12 (TD state), changes in the first and second timestamp difference accumulation values significantly increase.

In the embodiment, the HDC 212 sets the threshold value used for touchdown determination as follows: Firstly, the HDC 212 calculates the average (AVG) of the first timestamp difference accumulation values acquired in the non-TD state, and also calculates a standard deviation G thereof. After that, the HDC 212 sets a value of AVG+3σ as the threshold value to be compared with the first timestamp difference accumulation values. The HDC 212 compares the first timestamp difference accumulation values with the threshold value (AVG+3σ), and regards the DFH power corresponding to a minimum first timestamp difference accumulation value which exceeds the threshold value, as DFH power (i.e., DFH power at the touchdown (TD) point) necessary for bringing the magnetic head 11 into contact with the magnetic disk 12.

The HDC 212 processes the second timestamp difference accumulation values (i.e., the timestamp difference accumulation values acquired by the FFT operation) in the same was as the above. Specifically, the HDC 212 compares the second timestamp difference accumulation values with the threshold value (AVG+3σ), and regards the DFH power corresponding to a minimum second timestamp difference accumulation value which exceeds the threshold value, as DFH power (i.e., DFH power at the touchdown (TD) point) necessary for bringing the magnetic head 11 into contact with the magnetic disk 12.

Depending upon the circumstances of measurement, even at DFH power that does not cause the touchdown of the magnetic head 11, the corresponding difference accumulation value may exceed the threshold value (AVG+3σ), resulting in erroneous detection. In this case, it is sufficient if two-step determination using two threshold values is executed as follows: Firstly, the HDC 212 sets a threshold value of AVG+5σ higher than the threshold value of AVG+3σ, thereby detecting DFH power (hereinafter, the first DFH power) at which the magnetic head 11 is in reliable contact with the magnetic disk 12 (the magnetic head 11 is pressed against the magnetic disk 12). Subsequently, the HDC 212 switches the threshold value of AVG+5σ to the threshold value of AVG+3σ, and at the same time, sets the DFH power (hereinafter, the second DFH power) applied to the heating element, by gradually decreasing the first DFH power (e.g., in units of 1 dac) in an opposite manner to the above-mentioned case). The HDC 21 regards, as the touchdown-point DFH power, the second DFH power detected immediately before the magnetic head 11 is out of contact with the magnetic disk 12. This can prevent erroneous detection of the touchdown-point DFH power.

As described above, in the embodiment, touchdown determinations are executed using the first timestamp accumulation values (the results of the timestamp difference calculation), and the second timestamp accumulation values (the results of the timestamp value FFT operation & difference calculation). At each of the touchdown determinations, the DFH power necessary for bringing the magnetic head 11 into contact with the magnetic disk 12 is detected. By employing, as the touchdown determination value, the greater one of the thus detected DFH power levels, erroneous detection can be avoided.

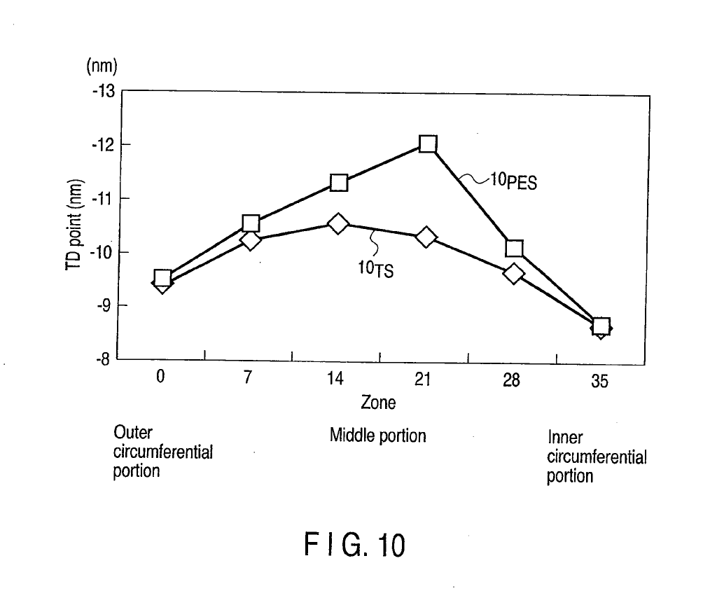

FIG. 10 shows an example of touchdown-point measurement results obtained by the above-described touchdown measuring method at different zones on the magnetic disk 12 on which the magnetic head 11 is positioned. In this case, it is assumed that 36 zones, ranging from zone 0 located at the outer circumferential portion of the disk to zone 35 located at the inner circumferential portion, are provided on the magnetic disk 12. FIG. 10 also shows touchdown measurement results obtained by the prior art using the PES.

In FIG. 10, a line graph 10_{TS} represents touchdown measurement results based on timestamp (timestamp method), and a line graph 10_{PES} represents touchdown measurement results based on conventionally known PES (PES method). Further, in FIG. 10, the vertical axis indicates the dynamic flying height (relative dynamic flying height) reduced when DFH power is supplied, supposing that the dynamic flying height assumed when no DFH power is supplied is 0 nm. The horizontal axis indicates the zone number assigned to the zone on the magnetic disk 12, on which the magnetic head 11 is positioned when touchdown measurement is executed.

As is evident from FIG. 10, at the inner and outer circumferential portions of the magnetic disk 12, the PES method and the timestamp method exhibit substantially equal measurement results, whereas at the radially middle portion therebetween, they exhibit significantly different measurement results. This is because fluctuation in PES due to touchdown is smaller at the radially middle portion than at the circumferential portions, which causes degradation of measurement accuracy, whereas in the timestamp method, reliable touchdown point measurement is realized even at the radially middle portion since a change in the rotational speed of the magnetic disk 12 can be accurately detected.

In recent magnetic disk drives, to improve the characteristic of the head disk interface (HDI), there is a tendency of coating the surface of the magnetic disk with a lubricating agent of a low frictional resistance. However, in the touchdown measurement using the PES method, if the surface of the magnetic disk is coated with a lubricating agent of a low frictional resistance, a change in PES value at the time of touchdown becomes small, which makes it difficult to detect the touchdown. In contrast, in the embodiment where the timestamp method is used, and touchdown is measured by detecting a change in the rotational speed of the magnetic disk 12, reliable touchdown detection with little influence of the lubricating agent can be realized.

Thus, in the embodiment, the touchdown point of the magnetic head 11, i.e., the point (DFH power) referred to when adjusting the dynamic flying height of the magnetic head 11 can be accurately measured. By adjusting the dynamic flying height of the magnetic head 11 based on the measurement result, the quality of read/write signals can be stabilized to thereby provide a magnetic disk drive of high performance. Further, by the above-described method of the invention, the touchdown point of the magnetic head 11 can also be measured accurately.

In the above-described at least one embodiment, touchdown of the magnetic head can be accurately detected even at the radially middle portion of the magnetic disk.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of detecting contact of a magnetic head with a magnetic disk by changing the dynamic flying height of the magnetic head in a magnetic disk drive, the method comprising:
detecting a change in rotational speed of the magnetic disk; and
detecting contact of the magnetic head with the magnetic disk based on the detected change in the rotational speed.

2. The method of claim 1, further comprising measuring timestamps, the timestamps being time intervals at which servo patterns are read by the magnetic head from servo areas discretely arranged on the magnetic disk,
wherein the change in the rotational speed is detected based on the timestamps measured.

3. The method of claim 2, wherein:
the measuring timestamps comprises:
measuring first timestamps in a first state in which the magnetic head is out of contact with the magnetic disk; and
measuring second timestamps in a second state in which the dynamic flying height of the magnetic head is made lower than in the first state to bring the magnetic head into contact with the magnetic disk;
the detecting a change in rotational speed comprises detecting, as a timestamp change, changes in the second timestamps relative to the first timestamps; and
the detected timestamp change being used as the detected change in the rotational speed.

4. The method of claim 3, wherein the detected change in the rotational speed corresponds to differences between the first timestamps and the second timestamps.

5. The method of claim 3, wherein:
the first state is a state in which the dynamic flying height of the magnetic head is not controlled; and
the second state is a state in which the dynamic flying height of the magnetic head is controlled.

6. The method of claim 5, wherein:
the measuring timestamps further comprises controlling the dynamic flying height of the magnetic head over a predetermined number of revolutions of the magnetic disk; and
the first and second states continue temporally.

7. The method of claim 3, wherein:
the detecting a change in rotational speed further comprises:
subjecting the first and second timestamps to Fourier transform; and
detecting changes in Fourier transform results of the second timestamps with respect to Fourier transform results of the first timestamps; and
the contact of the magnetic head with the magnetic disk is detected based on first changes in the second timestamps with respect to the first timestamps, and second changes in the Fourier transform results of the second timestamps with respect to the Fourier transform results of the first timestamps.

8. The method of claim 7, wherein the detecting contact comprises:
detecting the contact of the magnetic head based on the first changes; and
detecting the contact of the magnetic head based on the second changes; and
determining that the magnetic head is in contact with the magnetic disk, when the contact of the magnetic head is detected based on the first changes and the contact of the magnetic head based is detected based on the second changes.

9. The method of claim 2, wherein:
the measuring timestamps comprises:
measuring first timestamps in a first state in which the magnetic head is out of contact with the magnetic disk; and
measuring second timestamps in a second state in which the dynamic flying height of the magnetic head is made lower than in the first state to bring the magnetic head into contact with the magnetic disk;
the detecting a change in rotational speed comprises:
subjecting the first and second timestamps to Fourier transform; and
detecting, as a timestamp change, changes in Fourier transform results of the second timestamps with respect to Fourier transform results of the first timestamps; and
the detected timestamp change is used as the detected change in the rotational speed.

10. The method of claim 1, wherein the change in the rotational speed and the contact of the magnetic head with the magnetic disk are detected when quality of a read signal or a write signal in the magnetic disk drive is lower than a reference level.

11. A magnetic disk drive comprising:
a first detector configured to detect a change in rotational speed of a magnetic disk when a dynamic flying height of a magnetic head is changed; and
a second detector configured to detect contact of the magnetic head with the magnetic disk based on the detected change in the rotational speed.
